(19) United States
(12) Patent Application Publication
(10) Pub. No.: US 2007/0204309 A1
(43) Pub. Date: Aug. 30, 2007

(54) Method and apparatus for preserving internet protocol video services across an optical network element reboot

(75) Inventors: Marc R. Bernard, Miramar, FL (US); David P. Fredrickson, Annandale, VA (US); Douglas F. Ortega, Potomac, MD (US); Charles E. Rothrauff, Sterling, VA (US); Thomas E. Conklin, Leesburg, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 11/704,683

(22) Filed: Feb. 9, 2007

Related U.S. Application Data
(63) Continuation-in-part of application No. 11/265,493, filed on Nov. 1, 2005.

(51) Int. Cl. H04N 7/173

(52) U.S. Cl. 725/87; 725/86

(57) ABSTRACT

When an optical network terminal (ONT) is rebooted, for example, after being upgraded, the ONT may be not be ranged and provisioned for some time. This may disrupt services, such as video services provided to a customer. As such, a method and corresponding apparatus of ensuring continuous receipt of video services based on certain conditions in a passive optical network (PON) are provided. The method may include detecting at a PON element a condition indicating a change of states in receipt of video services, starting a timing mechanism having a default value stored in the PON element, and enabling receipt of video services at the PON element for an amount of time defined by the default value. Receipt of video services is enabled by maintaining a configuration for video services previously provisioned and re-provisioning the PON element with the maintained configuration. In this way, disruption to video services is reduced.

### RELATED APPLICATIONS

This application is a continuation in part of U.S. application Ser. No. 11/265,493 entitled, “METHOD AND APPARATUS FOR MAINTAINING ONT VIDEO BEHAVIOR DURING INITIAL ONT DEPLOYMENTS, ONT REBOOTS, AND LOSS OF OLT CONDITIONS” filed on Nov. 1, 2005, the entire teachings of which are incorporated herein by reference.

### BACKGROUND OF THE INVENTION

In a passive optical network (PON), a central office (CO) may communicate with a subscriber terminal using three wavelengths: (i) an analog video wavelength, (ii) a digital downstream communications wavelength, and (iii) a digital upstream communications wavelength. There are times when the central office loses communications with the subscriber terminal, such as when the subscriber terminal is upgraded and/or rebooted. Services, such as Internet Protocol (IP) video services, which are provided to a customer, may be “down” (i.e. interrupted or disabled) while the subscriber terminal is rebooting and waiting to be re-ranged, referred to as “down-time.” The amount of “down-time” may be several minutes depending on, for example, the number of other subscriber terminals also being rebooted.

### SUMMARY OF THE INVENTION

A method and corresponding apparatus according to one embodiment of the present invention includes: (i) detecting at a passive optical network (PON) element a condition indicating a change of state(s) in video services, (ii) starting a timing mechanism having a default value stored in the PON element, and (iii) enabling receipt of video services at the PON element for an amount of time defined by the default value. The receipt of video services at the PON element is enabled for the amount of time defined by the default value by maintaining a configuration for video services previously provisioned, and re-provisioning the PON element with the maintained configuration for video services.

### BRIEF DESCRIPTION OF THE DRAWINGS

The foregoing and other objects, features and advantages of the invention will be apparent from the following more particular description of example embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a network diagram of an example Passive Optical Network (PON) in which an optical network terminal (ONT) continues to provide video services for a limited length of time to a subscriber when an active communications link exists between a PON card and the ONT;

FIG. 2 is a block diagram of an ONT in accordance with embodiments of the present invention;

FIG. 3 is a flowchart of an example process performed by an ONT in accordance with embodiments of the present invention;

FIG. 4 is a flowchart of an example process performed by an ONT in accordance with embodiments of the present invention;

FIG. 5 is a flowchart of an example process performed by an ONT in accordance with embodiments of the present invention;

FIG. 6 is a block diagram of an example passive optical network (PON) in which embodiments of the present invention may be employed;

FIG. 7 is a block diagram of an example passive optical network (PON) providing services over a shared fiber and distribution fibers;

FIG. 8 is a block diagram of an example passive optical network 800 providing services to customers over downstream communications between an OLT and ONTs;

FIG. 9 is a block diagram of an example passive optical network providing IP video services to customers over downstream communications paths which are unicast in nature;

FIG. 10 is a block diagram of an example passive optical network providing IP video services to customers over a downstream communications path which is broadcast in nature;

FIGS. 11A-C are message diagrams illustrating maintaining at least one video channel previously viewed in accordance with embodiments of the present invention;

FIG. 12 is a chart providing an overview of events occurring at an OLT, an ONT, and a set-top box/television at three different instances in time;

FIG. 13 is a flowchart for an example process for ensuring continuous video service based on conditions in a passive optical network, in accordance with an embodiment of the present invention;

FIGS. 14A and 14B are flowcharts for example processes for maintaining at least one most previously viewed video service while alleviating a problem of a stale maintained configuration for video services, in accordance with embodiments of the present illustrate invention; and

FIG. 15 is a block diagram that illustrates an example passive optical network (PON) element for ensuring continuous receipt of video services, in accordance with embodiments of the present invention.

### DETAILED DESCRIPTION OF THE INVENTION

A description of example embodiments of the invention follows.

It is useful to a service provider to minimize an amount of time services, which are provided to a customer, such as Internet Protocol (IP) video services, are “down” or disrupted when the customer's subscriber terminal is rebooted or upgraded and waiting to be re-ranged. A method and corresponding apparatus for ensuring continuous receipt of video services based on certain conditions in a passive optical network (PON) is provided.

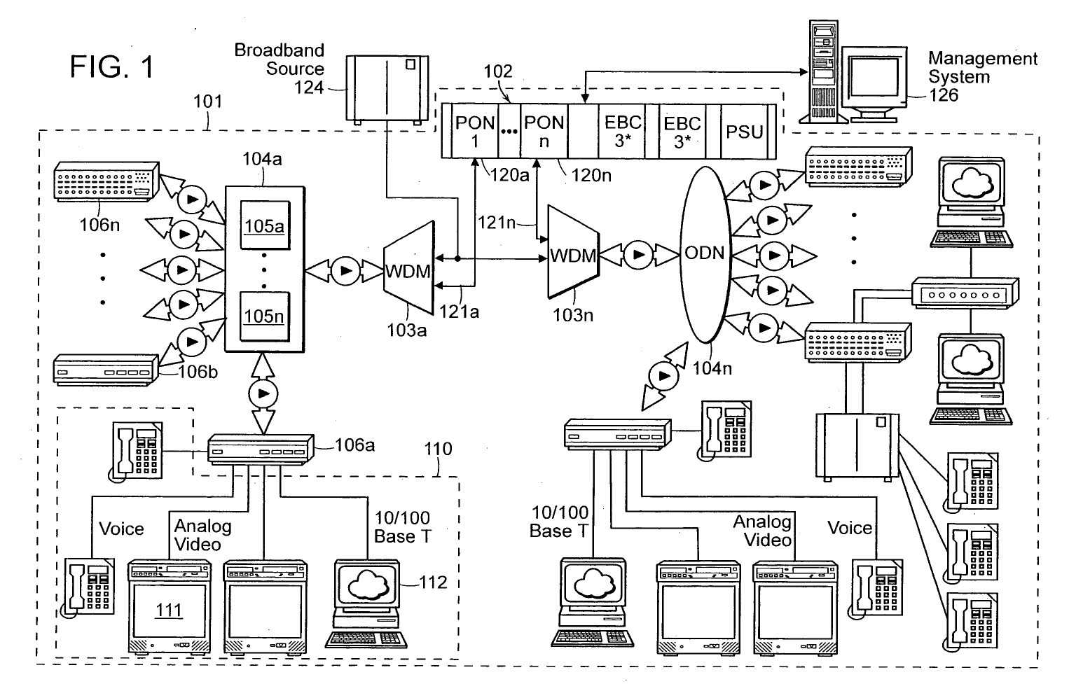

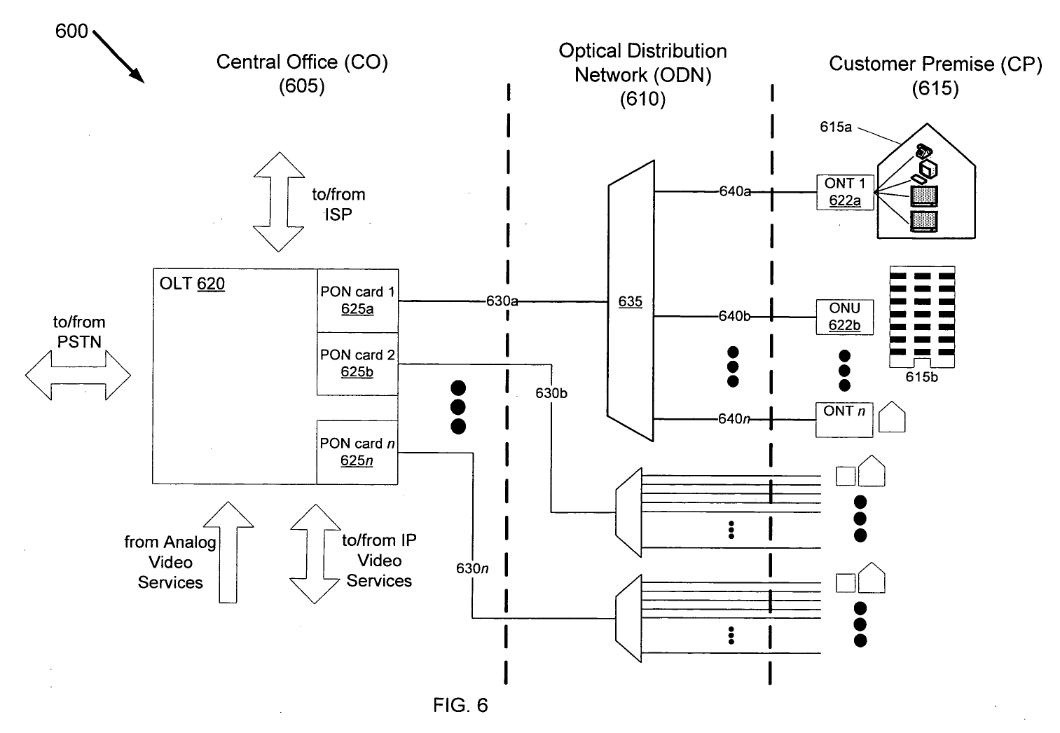

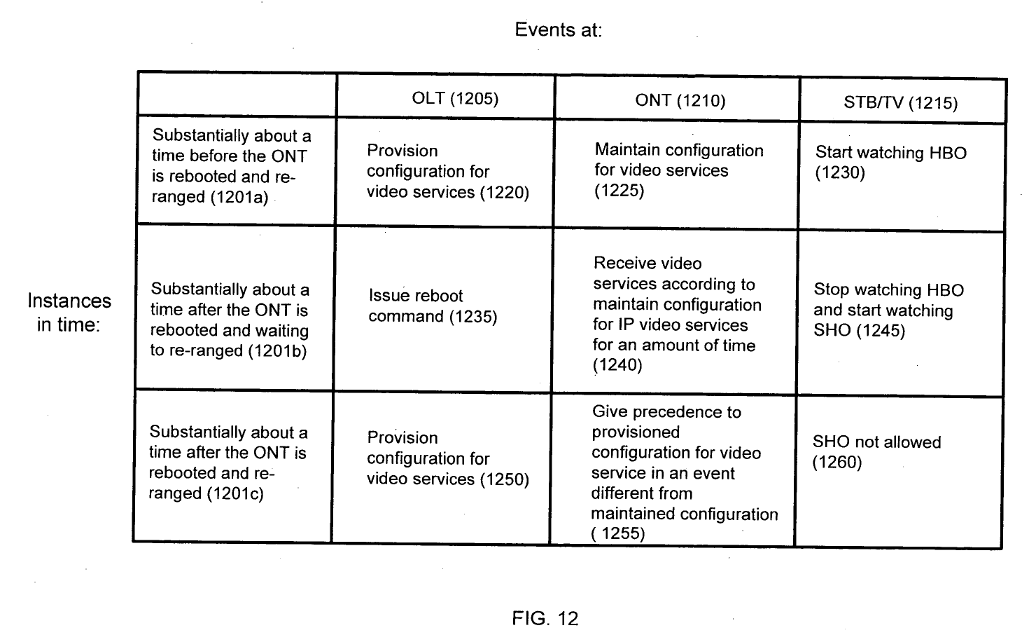

The following description is divided into three sections. The first section describes in reference to FIGS. 1-5 enabling receipt of video services at a passive optical network (PON) for a time defined by a default value. The second section describes in reference to FIGS. 6-11C a passive optical network (PON) in which example embodiments of the present invention may be deployed. The third section describes, in reference to FIGS. 12-15, example embodiments of the present invention.

FIG. 1 is a network diagram of an exemplary passive optical network (PON) 101. The PON 101 includes an optical line terminal (OLT) 102, wavelength division multiplexers 103a, . . . , 103n, optical distribution network (ODN) devices 104a, . . . , 104n, ODN device splitters (e.g., 105a, . . . , 105n associated with ODN device 104a), optical network terminals (ONTs) (e.g., 106a, 106b, . . . , 106n corresponding to ODN device splitters 105a, . . . , 105n), and customer premises equipment (e.g., 110). The OLT 102 includes PON cards 120a, . . . , 120n, each of which provides an optical feed (121a, . . . , 121n) to ODN devices 104a, . . . , 104n. An optical feed 121a, for example, is distributed through a corresponding ODN device 104a by separate ODN device splitters 105a, . . . , 105n to respective ONTs 106a, 106b, . . . , 106n in order to provide communications to and from customer premises equipment 110.

The PON 101 may be deployed for fiber-to-the-business (FTTB), fiber-to-the-curb (FTTC), and fiber-to-the-home (FTTH) applications. The optical fibers 121a, . . . , 121n in PON 101 may operate at bandwidths such as 155 Mb/sec, 622 Mb/sec, 1.25 Gb/sec, 2.5 Gb/sec or any other desired bandwidth implementations. The PON 101 may incorporate asynchronous transfer mode (ATM) communications, broadband services such as Ethernet access and video distribution, Ethernet point-to-multipoint topologies, and native communications of data and time division multiplex (TDM) formats. Customer premises equipment (e.g., 110) that can receive and provide communications in the PON 101 may include standard telephones e.g., Public Switched Telephone Network (PSTN) and cellular, Internet Protocol (IP) telephones, Ethernet units, video devices (e.g., 111), computer terminals (e.g., 112), digital subscriber line connections, cable modems, wireless access, as well as any other conventional device.

A PON 101 includes one or more different types of ONTs (e.g., 106a, 106b, . . . , 106n). Each ONT 106a, 106b, . . . , 106n, for example, communicates with an ODN device 104a through associated ODN device splitters 105a, . . . , 105n. Each ODN device 104a, . . . , 104n, in turn, communicates with an associated PON card 120a, . . . , 120n through respective wavelength division multiplexers 103a, . . . , 103n. Communications between the ODN devices 104a, . . . , 104n and the OLT 102 occur over a downstream wavelength and an upstream wavelength. The downstream communications from the OLT 102 to the ODN devices 104a, . . . , 104n may be provided at 622 megabytes per second, which is shared across all ONTs connected to the ODN devices 104a, . . . , 104n. The upstream communications from the ODN devices 104a, . . . , 104n to the PON cards 120a, . . . , 120n may be provided at 155 megabytes per second, which is shared among all ONTs connected to ODN devices 104a, . . . , 104n.

A broadband source 124, of which a cable television feed through an erbium doped fiber amplifier (EDFA) is just one example, may also provide video or other broadband data to the WDMs 103a, . . . , 103n using a single wavelength (hereinafter, video wavelength). The WDMs 103a, . . . , 103n multiplex the PON upstream and downstream communications wavelengths and the video wavelength and provide the resulting multiplexed signals to respective ODN devices 104a, . . . , 104n. Each ONT (e.g., 106a, 106b . . . , 106n) may monitor a broadband overlay signal provided by the broadband source 124. One example of a broadband overlay signal is a 1550 nanometer signal used for downstream video applications.

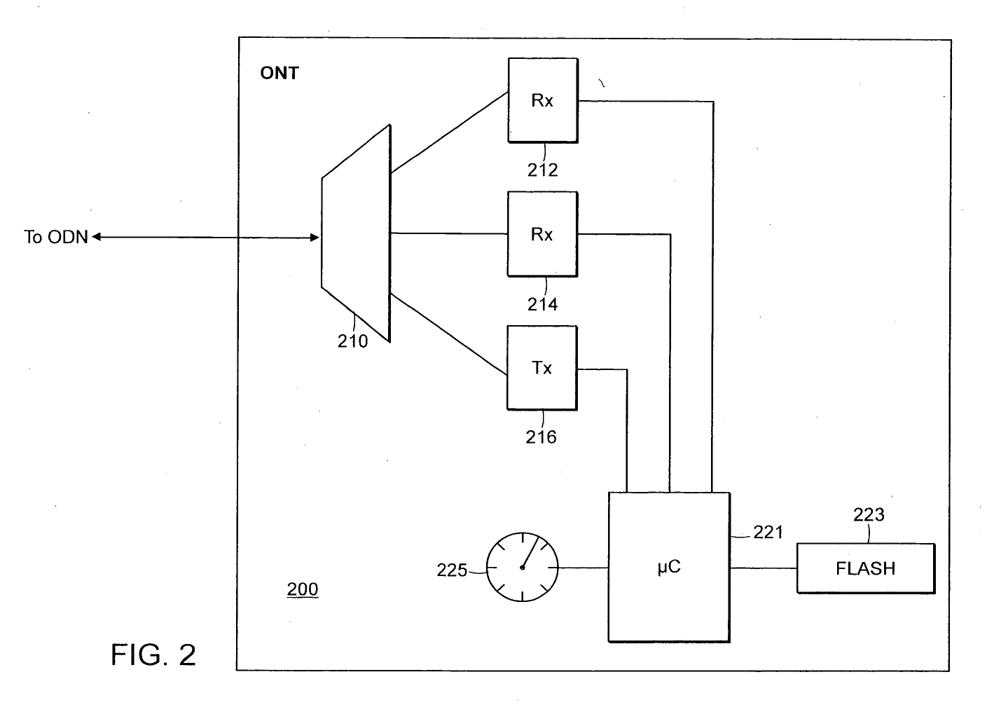

FIG. 2 is a block diagram of an ONT 200 according to an embodiment of the present invention. The ONT 200 comprises a splitter 210 which connects through a fiber to an ODN device splitter 105a of the optical network device 104a (FIG. 1). The splitter 210 may split the optical signal from the ODN device splitter into its three respective wavelengths (e.g., upstream and downstream communications wavelengths and the video or broadband data wavelength). Thus, the ONT 200 (i) receives video or broadband data 212, (ii) receives PON communications data, and (iii) transmits PON communications data 216. The ONT 200 further includes a microprocessor 221 which monitors and controls the transmission and receipt of the video and PON communications data. The microprocessor 221 is coupled to non-volatile flash memory 223 which may be used to store settings of a video service mode according to an embodiment of the present invention. The microprocessor 221 is further coupled to a timing mechanism 225, which may be used to enable video services for a given length of time.

In normal operation, a PON card of the OLT ranges an ONT to enable communications between the PON card and the ONT. Once the ONT is ranged, the PON card may provision the ONT to enable or disable video services to the ONT. In existing FTTP systems, however, the ONT may lose communications with the OLT for a variety of reasons.

First, there may be a fiber break in certain segments of the PON.

Second, the ONT may reboot, for example, in response to a command by the OLT. Reboots most often occur when the ONT is upgraded. The OLT may issue an emergency management system (EMS) command to the ONT to perform a hard reboot for troubleshooting purposes. The ONT may also reboot in response to actuating a switch on the ONT or in response to an internal command from the microprocessor.

Third, the ONT may lose communications with the OLT because there may be a problem in the OLT (e.g., a problem with a PON line card providing an OLT interface on the PON in which the ONT resides) or in the PON line cards (or other line cards that may be required to reboot or may be replaced with another line card). When the PON line card is replaced with another line card, the communication between the ONT and the OLT is lost, and an ONT loss of physical layer-loss of signal (ONT LOPL-LOS) condition occurs.

Fourth, the ONT may lose communications with the OLT because (i) there may be a bad connection between some ODN device splitters and a PON line card, which may cause high bit-error-rates; (ii) the ODN device splitter may simply lose connection with its corresponding ONT; or (iii) a misbehaving ONT (e.g., often referred to as a “rogue” ONT) may cause bad communications between all ONTs and the PON line card and thus cause all ONTs' ranging to go down.

Fifth, the ONT may lose communication with the OLT because, in some PON troubleshooting scenarios, the ONT may be commanded to perform an emergency stop (per ITU-G.983.1) (“E-STOP”) via the disable_serial_number PLOAM messages, at which point the ONT must stop regular communications with the OLT until commanded to come out of the emergency stop on state.

The above list of reasons why an ONT may lose communications with a PON line card is not meant to be an exhaustive list. There are many other reasons for loss of communications between an ONT and a PON line card. For whatever reason the ONT loses ranging with the OLT, the ONT defaults to its video service enabled or disabled mode whether or not the ONT is provisioned to offer video services to its subtended subscriber.

In the case when the ONT's default attribute for video services is enabled, a user can connect, via such an ONT in any PON network, to a video server (not shown) and receive video services at no charge from the service provider. Ideally, the service provider wants to change video services whether or not an ONT has lost communications with the OLT. In the case when the ONT's default video services mode is disabled (for example, when an ONT a shipped from a manufacturer), a field technician cannot connect an ONT to the PON to determine if the ONT even receives video. This is a useful troubleshooting technique in the home to ensure the ONT is functional and that fiber is linked to the home. Typically, an ONT defaults to the disabled video services mode.

According to an embodiment of the present invention, a mechanism is provided that allows the ONT to continue offering video services even when the ONT loses communications with the OLT (e.g., across reboots). In one embodiment, the ONT may maintain the last known Video Services Mode in flash memory. After an OLT loses ranging with an ONT, the ONT maintains the last known video service mode for a predetermined length of time as defined by a timing mechanism. In this way, after a timing duration or threshold, a user cannot connect an ONT in any PON network to receive free video services.

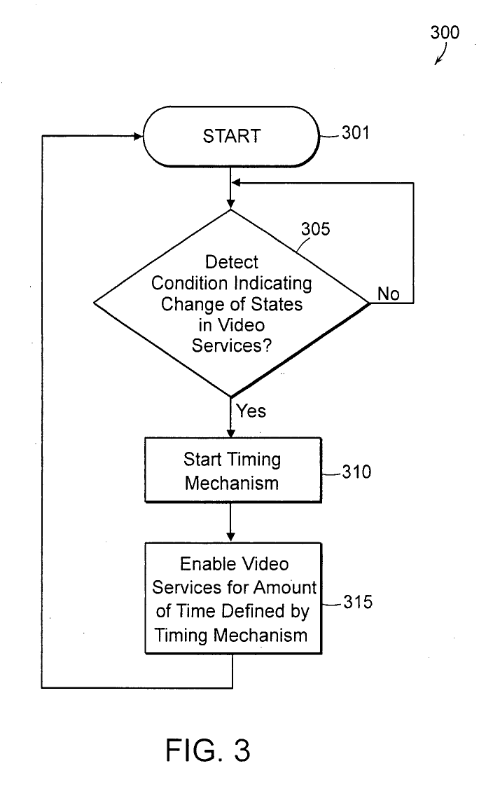

FIG. 3 is a flowchart of an example process 300 performed by an ONT in accordance with embodiments of the present invention. After starting (301) the process 300 determines whether or not the ONT detects (305) a condition indicating a change of states in video services. A condition indicating a change of states in video services may include any of the conditions listed above (i.e., reasons why an ONT loses communications with a PON card at the OLT). If the process 300 does not detect (305) a condition indicating a change of state in video services, then the process 300 repeats determining whether the ONT detects (305) a condition indicating a change of states and video services. If the process 300 does detect (305) such a condition, the process 300 (i) starts (310) a timing mechanism (e.g. clock 225, FIG. 2) and (ii) enables (315) video services for an amount of time defined by the timing mechanism. After an amount of time defined by the timing mechanism expires, the process 300 may resume a video service mode stored in memory before restarting (301) the process 300. For example, if the video service mode stored in memory is set to disabled, the process 300 disables video services.

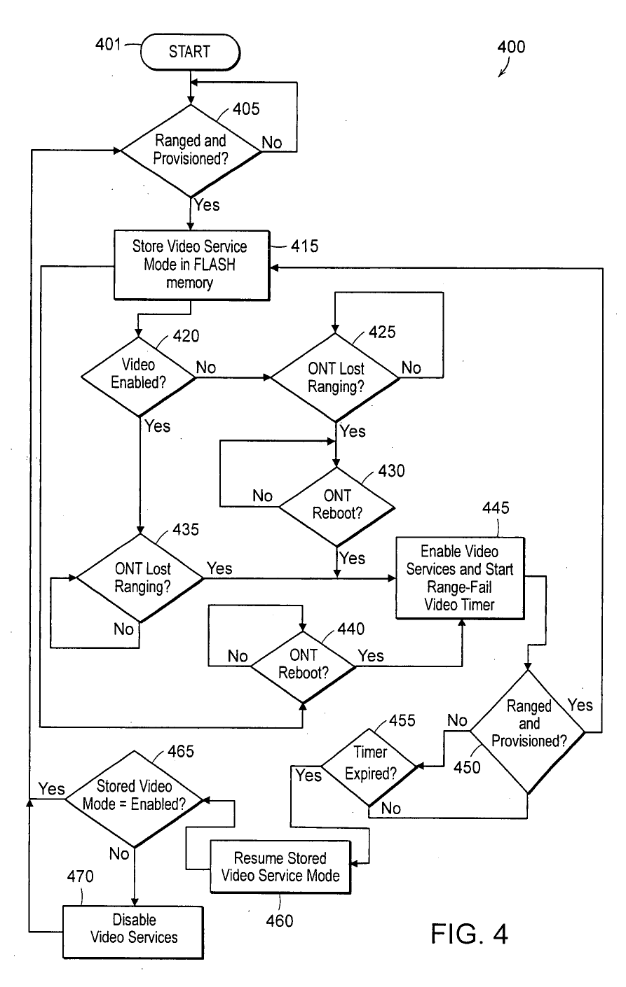

FIG. 4 is a flowchart of a detailed process 400 according to an embodiment of the present invention. The process 400 may be implemented in software, stored on a computer-readable medium (e.g., CD-ROM), and loaded and executed in the microprocessor of an ONT. After starting (401), the process 400 determines whether or not the ONT is ranged and provisioned (405) by the PON line card of the OLT. In a PON, after the PON line card ranges the ONT, it may provision the ONT to operate according to certain modes, such as a video service mode. In this way, a service provider may control the services being provided to the ONT. If the ONT has not been ranged and provisioned by the PON line card, the process 400 repeats to determine whether the ONT is ranged and provisioned (405).

If the ONT is ranged in provisioned (405), the process 400 stores (415) provisioned video service mode settings in the ONT's FLASH memory. An ONT in inventory may be provisioned with video service mode settings before being deployed, and, thus, the video service mode settings are stored in such an ONT's FLASH memory. Inventory may include new ONTs and used ONTs (e.g., refurbished ONTs ready for redeployment).

The process 400 next determines whether or not video services have been enabled (420). If video services have not been enabled (420), but instead they have been disabled, the process 400 proceeds to determine whether or not the ONT has lost ranging (425) with the PON line card. If the process 400 determines that the ONT has lost ranging (425) with the PON line card, the process 400 determines whether or not the ONT has been rebooted (430). If on the other hand, the process 400 determines that the ONT has not lost ranging (425) with the PON line card, the process 400 repeats determining whether the ONT has lost ranging (425).

If the ONT has lost ranging (425) and the ONT has not been rebooted (430), the process 400 continues checking for an ONT reboot (430). If the ONT has lost ranging (425) and the ONT has been rebooted (430), the process 400 enables (445) video services and starts a range-fail video timer, which may be set for a default amount of time. For example, the default amount of time may be sufficient for troubleshooting purposes or may be a value that is determined by the customer. Thus, the ONT does not need to be ranged by the OLT in order to provide video services for test or troubleshooting purposes. In a typical scenario, a technician is able to troubleshoot the ONT before the range fail video timer expires.

The default timer value may be a few minutes or many hours (e.g., 1 to 72 hours). The timer value may be stored in the ONT, for example, in FLASH memory. The timer value may also be updated, for example, locally by a technician or remotely by the Emergency Management System (EMS). The range-fail video timer may be any type of timing mechanism capable of measuring or provide information for measuring a given length of time such as a counter or a monitoring device monitoring a clock.

Referring again to the “video enabled” determination (420), after the process 400 determines that the video service mode has been set to enabled (420), the process 400 proceeds to determine whether or not the ONT has lost ranging (435) with the PON line card. If the ONT has indeed lost ranging (435) with the PON line card, the process 400 enables (445) video services and starts the range-fail video timer. If the ONT has not lost ranging (435) with the PON line card, the process 400 continues to monitor the state of ranging (435) between the ONT and the PON line card.

After the process 400 stores (415) the provisioned video service mode settings in FLASH memory, the process 400 monitors whether or not the ONT has rebooted (440). In other words, after the process 400 determines (440) that the ONT (or an ONT microprocessor) has not been rebooted, the process 400 repeats (440). Once the process 400 determines that the ONT has rebooted (440), the process 400 proceeds to enable video services and starts the range-fail video timer (445).

After the process 400 enables (445) video services and starts the range-fail video timer, the process 400 monitors (450) whether or not the ONT has been ranged and provisioned. If the ONT has been ranged and provisioned (450), the process 400 stores (415) the provisioned video service mode settings in the ONT's FLASH memory. If instead the ONT has not been ranged and provisioned (450), the process 400 proceeds to determine (455) whether or not the range-fail video timer has expired. If the range-fail video timer has not expired (455), the process 400 continues to monitor whether or not the ONT has been ranged and provisioned (450). However, if the range-fail video timer has expired (455), the process 400 resumes the video service mode (460) according to the video service mode settings stored in the FLASH memory. Next, the process 400 determines (465) whether or not the stored video service mode settings are set to enabled. If the video service mode is set to enable (465), the process 400 returns to determine (405) whether or not the ONT has been ranged or provisioned. Otherwise, the process 400 disables video services (470) and then returns to determine whether or not the ONT has been ranged for provisioned (405).

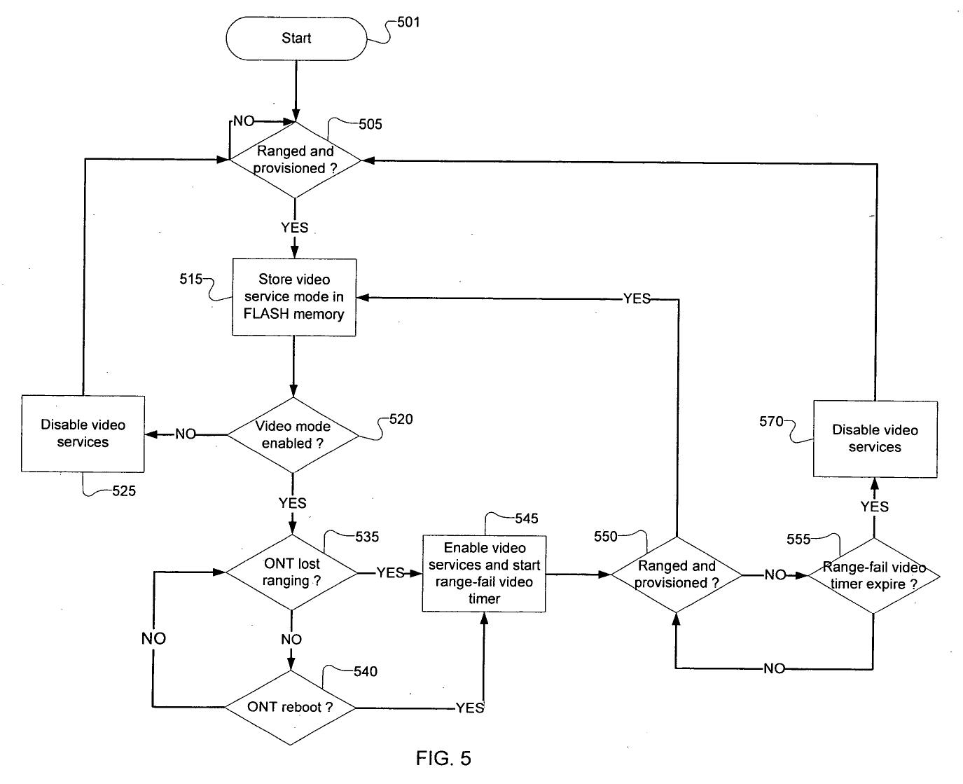

FIG. 5 is a flowchart of a process 500 according to another embodiment of the present invention. After starting (501), the process 500 determines whether or not an ONT has been ranged and provisioned (505) by a PON line card of the OLT. If the ONT has not been ranged and provisioned by the PON line card, the process 500 repeats to determine whether or not the ONT has been ranged and provisioned (505).

If the ONT is ranged and provisioned (505), the process 500 stores (515) the provisioned video service mode settings in the ONT's FLASH memory. The process 500 determines whether or not a video service mode has been set to enabled (520). If the video service mode has not been set to enabled, but instead has been set to disabled, the process 500 proceeds to disable video services (525) and returns to determine whether the ONT has been provisioned and ranged (505). Thus, a timing mechanism is disabled when the video service mode is set to disabled.

If the video service mode has been set to enabled (520), the process 500 proceeds to determine whether or not the ONT has lost ranging (535) with the PON line card. If the ONT has indeed lost ranging (535) with the PON line card, the process 500 enables video services and starts a range-fail video timer (545). If the ONT, however, has not lost ranging with the PON line card, the process 500 proceeds to determine whether or not the ONT has rebooted (540).

If the process 500 determines the ONT has not rebooted (540), the process 500 returns to determine whether or not the ONT has lost ranging (535) with the PON line card. If however, the process 500 determines the ONT has rebooted (540), the process 500 proceeds to enable video services and starts the range-fail video timer (545).

After the process 500 enables (545) video services and starts the range-fail video timer, the process 500 monitors (550) whether or not the ONT has been ranged and provisioned. If the ONT has been ranged and provisioned (550), the process 500 stores (515) the provisioned video service mode settings in the ONT's FLASH memory. If instead the ONT has not been ranged and provisioned (550), the process 500 proceeds to determine (555) whether or not the range-fail video timer has expired. If the range-fail video timer has not expired (555), the process 500 continues to monitor whether or not the ONT has been ranged and provisioned (550). However, if the range-fail video timer has expired (555), the process 500 disables (570) video services and then returns to determine whether the ONT has been ranged and provisioned (505).

It should be understood that video services may be disabled after a predetermined amount of time by, for example, disabling receipt of video services at the ONT or by disabling transmission of video services towards a customer or subscriber.

It should be further understood that the range-fail video timer should be sufficiently long enough to allow a technician to troubleshoot the ONT and ensure that the ONT is able to receive video services. Furthermore the range-fail video timer should be sufficiently long enough to detect, for example, a valid downstream 1550 nm signal from the PON line card. However, the length of time monitored by the timer should not be so long as to allow a customer to “steal” video services for extended periods of time. The length of time monitored by the timer should be short enough to make it inconvenient to watch any video services of programming.

FIGS. 6-11C are network and signal diagrams of a passive optical network (PON) supporting embodiments of the present invention. FIGS. 12-15 are diagrams and flowcharts illustrating example embodiments of the present invention.

FIG. 6 illustrates an example passive optical network (PON) 600 with a central office (CO) 605, optical distribution network (ODN) 610, and customer premise (CP) 615 in which embodiments of the present invention may be employed.

In one embodiment, continuous video services are ensured based on certain conditions in a passive optical network (PON) by detecting at a PON element a condition indicating a change of states in video services, triggering a timing mechanism having a default value stored in the PON element, and enabling receipt of video services at the PON element for an amount of time defined by the default value.

In some embodiments, receipt of video services at a PON element is enabled for an amount of time defined by a default value by maintaining a configuration for video services previously provisioned and receiving video services according to the maintained configuration for video services for the amount of time defined by the default value.

One embodiment maintains the configuration for video services previously provisioned by maintaining a state of receipt of the video services and maintaining at least one downstream communications path for video services for delivering the video services. Another embodiment further maintains a list of allowable video services and maintains at least one video service previously viewed.

While one embodiment receives video services according to the maintained configuration, another embodiment gives precedence to a configuration for video services provisioned by a second PON element, in an event the maintained configuration for video services differs from the configuration for video services provisioned by the second PON element.

In a particular embodiment, at least one video service previously viewed is maintained by monitoring for Internet Group Management Protocol (IGMP) Multicast Membership Report and IGMP Multicast Leave Group Membership messages, indicating a change from a first video service to a second video service. Alternatively, in another embodiment, at least one video service previously viewed is maintained by sending an IGMP Group Membership Query message to determine at least one video service requested.

To enable receipt of video services at the PON element for an amount of time defined by the default value, one embodiment additionally determines whether video services are available by monitoring a downstream communications path for available video services. Yet, another embodiment further determines whether video services are available by monitoring the downstream communications path for a message indicating video services are available.

One embodiment may maintain a configuration for video services previously provisioned by storing the configuration internally to a PON element.

In one embodiment, the change of states includes at least one of the following: fiber-break in certain segments of the PON, the PON element reboots for purposes of troubleshooting or upgrading the PON element, the PON card or other line card reboots or is replaced with another line card, poor connections with some Optical Distribution Network (ODN), and a misbehaving PON element causes bad communications between PON elements.

In another embodiment, the PON element enters a provisioned video service mode when the amount of time defined by the default value ends. The entered provisioned video service mode uses information provided by another PON element.

In yet another embodiment, the default value of the timing mechanism is changed from a remote or external source, is stored in nonvolatile memory, or combinations of thereof.

In still another embodiment, continuous video services are ensured by additionally returning the timing mechanism to its original state in an event a loss of ranging occurs. Alternatively, continuous video services are ensured by additionally disabling the receipt of video services after the amount of time defined by the timing mechanism expires.

Continuing to refer to FIG. 6, at the central office 605, an optical line terminal (OLT) 620 is communicatively coupled or otherwise interfaced to, for example, an Internet service provider (ISP) (not shown), a public switched telephone network (PTSN) (not shown), video analog services, and IP video services. The OLT 620 includes passive optical network cards 625a . . . 625n.

Services such as data, telephony, and video are provided to customers over shared fibers 630a . . . 630n. At the optical distribution network 610, services provided over the shared fiber 630a . . . 630n are split by a splitter 635 onto two or more distribution fibers 640a . . . 640n.

Communications corresponding to provided services, which are going away from the central office 605 toward the customer premise 615, are hereinafter referred to as downstream communications. Conversely, communications corresponding to provided services, which going away from the customer premise 615 toward the central office 605, are hereinafter referred to as upstream communications.

Services may be deployed in fiber-to-the-home (FTTH), fiber-to-the premise (FTTP), or fiber-to-the-curb (FTTC) architectures. In the case of FTTH, at the customer premise 615, for example a home 615a, services are provided to the customer through an optical network terminal (ONT) 622a. In the case of FTTH, at the customer premise 615, for example an apartment 615b or other multi-dwelling unit (MDU), services are provided to the customers by an optical network unit (ONU) 622b.

While embodiments of the present invention are described in reference to an ONT, one skilled the art will readily recognize that the principles of the invention apply to both an ONT and an ONU or other termination configured to support embodiments as described herein.

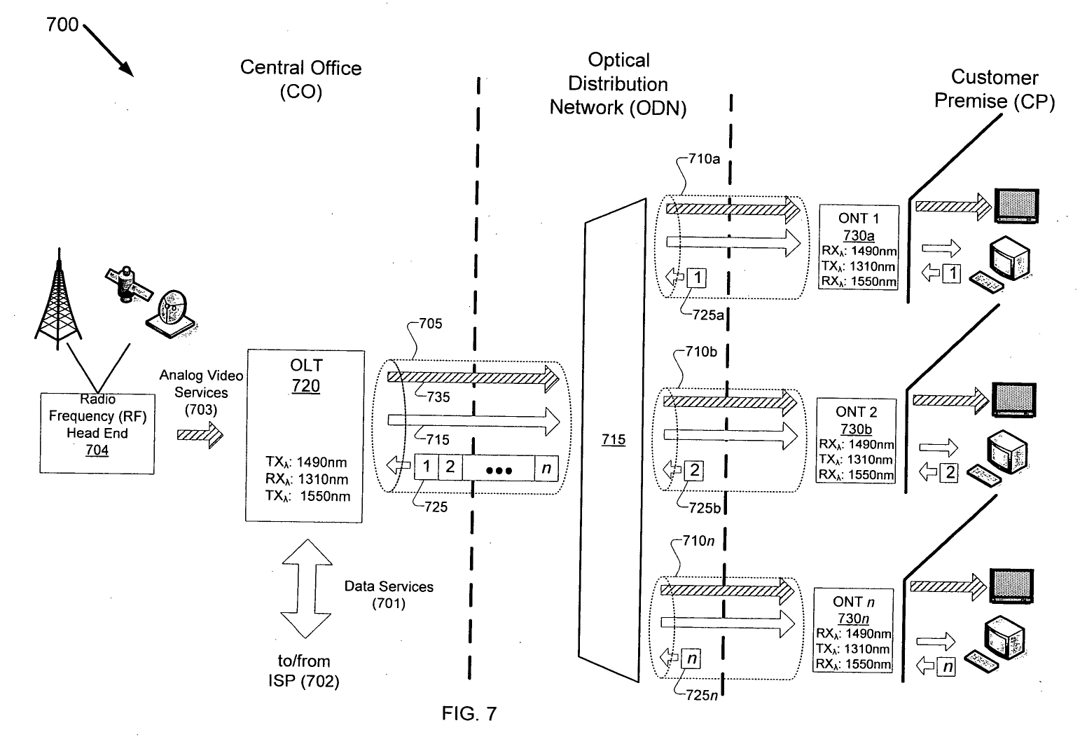

FIG. 7 illustrates an example PON 700 providing services over a shared fiber 705 and distribution fibers 710a . . . 710n. To provide services, such as data services 701 to and from an ISP 702 over the shared fiber 705 and distribution fibers 710a . . . 710n, downstream communications 715 and upstream communications 725a . . . 725n are multiplexed or otherwise combined by using different wavelengths for each of the communications directions, as is known in the art.

The downstream communications 715 use a first wavelength, for example, 1490 nanometers (nm), while the upstream communications 725a . . . 725n use a second wavelength, for example, 1310 nm. That is, services provided to customers over the downstream communications 715 are transmitted by an OLT 720 at 1490 nm and received by ONTs 730a . . . 730n at 1490 nm.

To add or to overlay an additional service, such as analog video services 703 from an radio frequency (RF) head end 704, over the shared fiber 705 and the distribution fibers 710a . . . 710n, an overlay 735 is assigned or otherwise uses a third wavelength. For example, the overlay 735 may use a wavelength of 1550 nm. That is, services provided to customers over the overlay 735 are transmitted by the OLT 720 at 1550 nm and received by the ONTs 730a . . . 730n at 1550 nm.

Because different wavelengths may be used to provide services over a shared fiber, a configuration for ensuring continuous video services may include a wavelength corresponding to the provided video services.

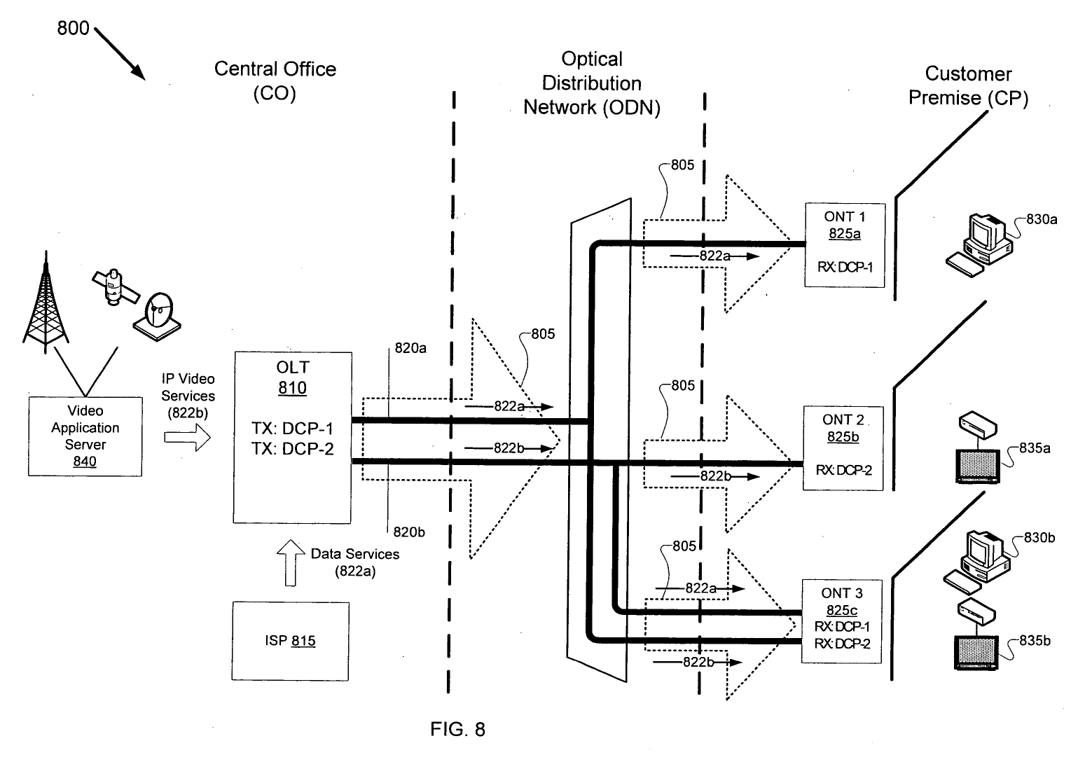

FIG. 8 illustrates an example passive optical network (PON) 800 providing services to customers over downstream communications 805 between an OLT 810 and ONTs 825a . . . 825c. Services, such as data services 822a and IP video services 822b are provided over the downstream communications 805 using one or more downstream communications paths 820a, 820b.

Each service 822a, 822b uses a different, respective, downstream communications path 820a, 820b to provide service to customers. For example, data services 822a are provided to customers over the downstream communications path 820a (DCP-1) for data services 822a. Data services 822a from an ISP 815 are transmitted by the OLT 810 over the downstream communication path 820a. In this example, the data services 822a from the ISP 815 are received by the ONTs 825a and 825b over the downstream communications path 820a for data services 822a. The data services 822a from the ISP 815 are then provided to computers 830a and 830b.

In another example, IP video services 822b are provided to customers over the downstream communications path 820b (DCP-2) for IP video services 822b. IP video services 822b from a video application server 840 are transmitted by the OLT 810 over the downstream communications path 820b for IP video services 822b. In this example, the IP video services 822b from the video application server 840 are received by the ONTs 825b and 825c over the downstream communications path 820b for IP video services 822b. The IP video services 822b are then provided to set-top boxes/televisions 835a and 835b.

At least one of the downstream communications paths 820a, 820b (e.g., the downstream communications path 820a for data services 822a) may be, for example, an asynchronous transport mode (ATM) virtual channel connection (VCC) or a Gigibit-capable passive optical network (G-PON) encapsulation mode (GEM) port, in accordance with International Telecommunication Union (ITU) specification G.984.3, “Gigibit-capable Passive Optical networks (G-PON): Transmission convergence layer specification,” section 5.3.

Because a downstream communications path may be used to provide services over downstream communications, a configuration for ensuring continuous video services may include the downstream communications path over which the video services are provided.

In contrast, some services, such as analog video services, are provided over a separate downstream communications (e.g., the overlay of FIG. 7) without having to specify paths in the communications themselves. As such, in the analog video world, a passive optical network (PON) element, such as an ONT, needs only to pass the entire analog radio frequency (RF) signal downstream towards a customer to provide analog services. In stark contrast, in the IP video world, the same PON element needs to be a much smarter and more complex device.

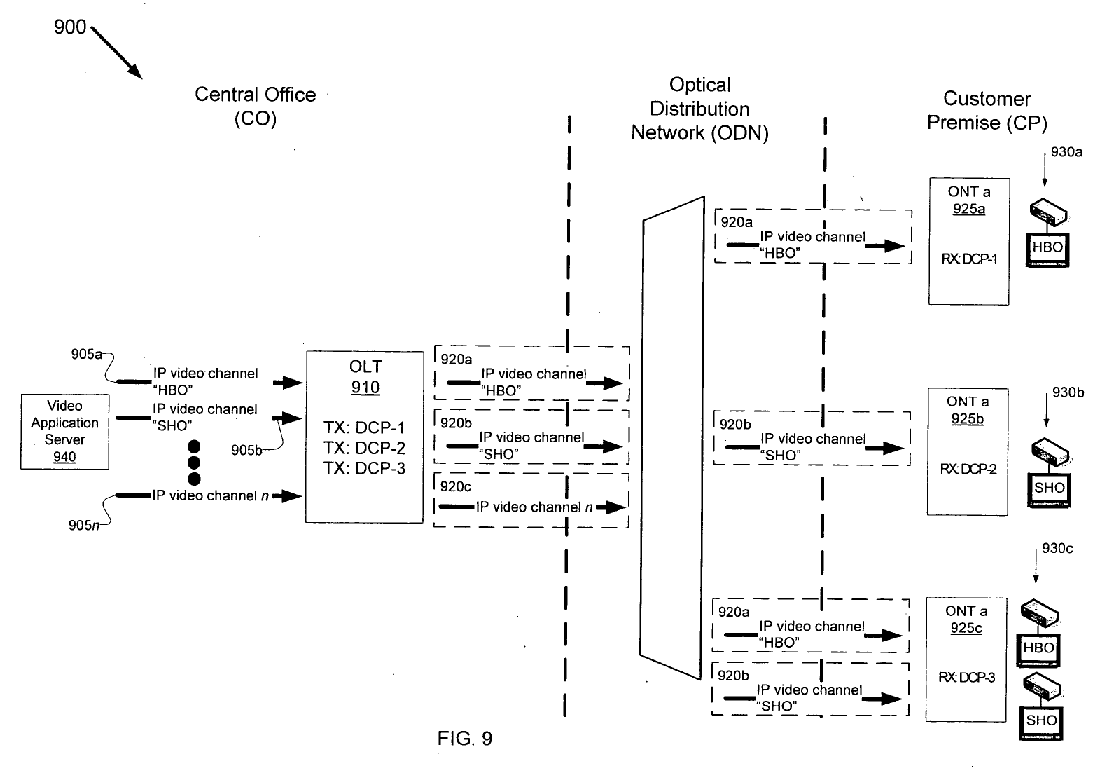

As described in greater detail below in reference to FIGS. 9-15, providing IP video services may require a PON element to maintain knowledge of specific IP video channels currently being viewed or previously viewed by a customer. Furthermore, the PON element may be required to monitor IP video channel change requests by the customer in order to provide IP video services.

FIG. 9 illustrates an example PON 900 providing IP video services to customers over downstream communications paths 920a . . . 920c. In this example, the downstream communications paths 920a . . . 920c are “unicast” (or one-to-one) in nature. That is, IP video services are provided to each customer over individual downstream communications paths.

For example, a first IP video service 905a (e.g. an IP video channel “HBO”) from a video application server 940 is transmitted by an OLT 910 over a first downstream communications path 920a (DCP-1) to a first customer premise 930a. The first IP video service 905a from the video application server 940 is received by a first ONT 925a over the first downstream communications path 920a.

Similarly, a second IP video service 905b (e.g. IP video channel “SHO”) from the video application server 940 is transmitted by the OLT 910 over a second downstream communications path 920b (DCP-2) to a second customer premise 930b. The second IP video service 905b from the video application server 940 is received by a second ONT 925b over the second downstream communications path 920b.

It should be noted that each IP video service provided to a customer is provided over a downstream communications path particular to that IP video service, even if two or more IP video services provide the same IP video channel. For example, even though the IP video channel HBO is provided over the first downstream communications path 920a, to provide the same IP video channel to a third customer premise 930c, the IP video channel HBO is provided over a third downstream communications path 920c (DCP-3).

This type of provided IP video services is an example of video on demand (VOD).

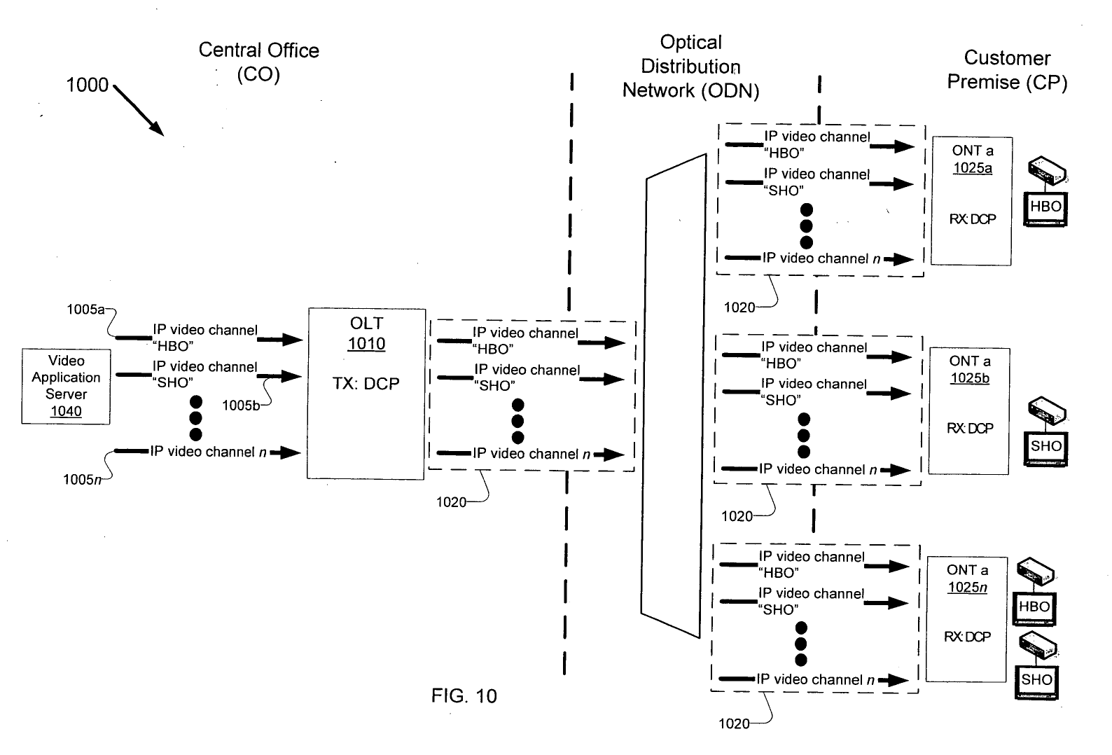

FIG. 10 illustrates an example PON 1000 providing IP video services to customers over a downstream communications path (DCP) 1020. In this example, the downstream communications path 1020 is “broadcast” (or one-to-all) in nature. That is, IP video services are provided to all customers over the downstream communications path 1020. For example, IP video services, such as IP video channel “HBO” 1005a, IP video channel “SHO” 1005b through IP video channel n 1005n from a video application server 1040, are transmitted by an OLT 1010 over the downstream communications path 1020. The IP video services from the video application server 1040 are received by ONTs 1025a . . . 1025n over the downstream communications path 1020. Since the downstream communications path 1020 is accessible to all the ONTs 1025a . . . 1025n, the downstream communications path 1020 is said to be “broadcast” in nature.

Moreover, IP video services provided over the downstream communications path 1020 (e.g., all IP video channels offered or subscribed to by the ONTs 1025a . . . 025n) are accessible by all the ONTs 1025a . . . 1025n. In this way, multiple IP video services or different IP video services may be offered over multiple downstream communications paths. For example, a first grouping of IP video channels A, B, and C are provided over a first downstream communications path, while a second grouping of IP video channels D, E, and F are provided over a second downstream communications path.

Because a particular video service may be provided over a particular downstream communications path, a configuration for ensuring continuous video services may include the particular downstream communications path over which the video service is provided.

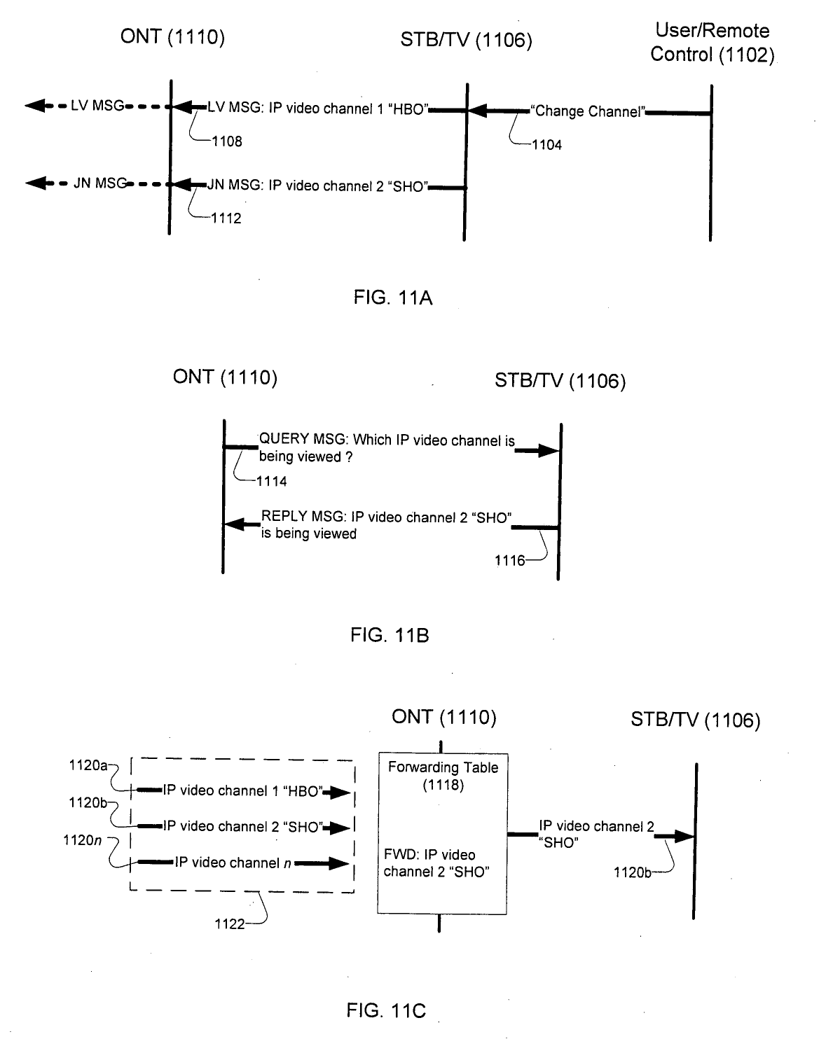

FIG. 11A is a signal diagram illustrating signals passed along example nodes of a PON resulting from a user 1102 changing an IP video channel or otherwise switching from a first IP video channel to a second IP video channel. The user 1102, typically via a remote control (not shown), issues a “change channel” request command 1104 to a set-top box 1106. The set-top box 1106 sends a “leave” signal or message 1108, identifying a first IP video channel from which to leave, to an ONT 1110, where the “leave” signal or message 1108 indicates that the set-top box 1106 no longer wants the (first) corresponding first IP video channel to be sent via downstream communications. The ONT 1110 processes the “leave” signal or message 1108. Alternatively, the ONT 1110 passes the “leave” signal or message 1108 upstream to, for example, a video application server (not shown).

The set-top box 1106 sends a “join” signal or message 1112, identifying a second IP video channel to which to “join”, to the ONT 1110, where the “join” signal or message 1112 indicates that the set-top box 1106 wants the corresponding (second) IP video channel to be sent via downstream communications. Again, the ONT 1110 processes the “join” signal or message 1112 or alternatively passes the “join” signal or message 1112 upstream to, for example, a video application server (not shown).

Whether the ONT 1110 processes or passes the “leave” message 1108 or “join” message 1112, in either instance, the ONT 1110 is aware of the messages. That is to say, the ONT 1110 is capable of “snooping” or otherwise monitoring messages sent upstream from the set-top box 1106.

By monitoring messages sent upstream from the set-top box 1106, from the “leave” message 1108 the ONT 1110 is aware of which IP video channel was viewed before the user 1102 changed IP video channels. Similarly, from the “join” message 1112, the ONT 1110 is aware of which IP video channel was viewed after the user 1102 changed IP video channels. In this way, a video service currently being viewed may be determined by monitoring “leave” and “join” messages used to request a change from a first video service to a second video service.

It is possible however, the ONT is unable to monitor or otherwise misses the most recent “leave” and “join” messages. For example, the user 1102 changes IP video channel while the ONT is rebooting. Thus, it may be more accurate to say a video service previously viewed rather than a video service currently being viewed is determined by monitoring “leave” and “join” messages. Accordingly, by monitoring “leave” and “join” messages, an at least one video service previously viewed may be determined and may be maintained to ensure continuous video services.

Alternatively, as illustrated in FIG. 11B, a video service previously viewed may be determined by querying the set-top box 1106. In this example, the set-top box 1106 is queried by the ONT 1110 with a query signal or message 1114. The query signal or message 1114 requests the video service currently being viewed be identified. In response, the set-top box 1106 sends a reply signal or message 1116 identifying the video service currently being viewed. In this way, the video service currently being viewed may be determined by sending the query message 1114. Accordingly, by sending a reply signal or message, an at least one video service previously viewed may be determined and may be maintained to ensure continuous video services.

Alternatively, as illustrated in FIG. 11C, a video service previously viewed may be determined by consulting a forwarding table 1118. The forwarding table 1118 may be said to act as a filter by forwarding certain video services to the set-top box 1106 and not forwarding other video services. For example, n number of IP video channels 1120a . . . 1120n are provided over a downstream communications path 1122 in the example of FIG. 11C. The forwarding table 1118 forwards the IP video channel 1120b, but not the IP video channels 1120a and 1120c . . . 1120n. In this way, the video service currently being viewed may be determined from which video service is forwarded and which video services are not. Accordingly, by consulting a forwarding table, at least one video service previously viewed may be determined and may be maintained to ensure continuous video services.

The “join” “leave”, and query messages described above may in some embodiments be Internet Group Management Protocol (IGMP) messages, described in Internet Engineering Task Force (IETF) Request For Comments (RFC) 1112 (version 1), RFC 2236 (version 2), and RFC 3376 (version 3). Some embodiments may employ a “snooping” (or proxying) technique in accordance with IETF Internet-Draft draft-ietf-magma-snoop-12.txt entitled, “Considerations for IGMP and MLD Snooping Switches.”

In an IP video world, an end-user (or customer) uses IP video equipment capable of understanding how to offer or otherwise provide IP video services. One common protocol used by IP video equipment and other such network equipment to offer IP video services is the Internet Group Management Protocol (IGMP).

In the context of IGMP, there is an IGMP Client (e.g., the set-top box of FIG. 11) and at least one IGMP Host (e.g., the video application server of FIG. 8). For simplicity, in a typical IGMP (version 2) manner, the IGMP Client (or other IGMP-capable device) subscribes to a specific channel by sending an IGMP Multicast Membership Report message upstream to the IGMP Host to “join” a specific IP video channel or service. Similarly, if the end-user changes channels, the IGMP Client sends an IGMP Multicast Leave Group message upstream to the IGMP Host to “leave” a first IP video channel and an IGMP Multicast Membership Report message to “join” a second IP video channel.

Additionally, the IGMP client responds to an IGMP Group Membership Query message to allow, for example, a multicast router (e.g., an ONT or an OLT configuring to route multicast data) to determine if any IP video channels should be forwarded or otherwise communicated to the IGMP client.

One skilled in the art will readily recognize that monitoring “leave” and “join” messages, or sending a query message requesting at least one most recently viewed video service be identified, to maintain at least one most recently viewed video service is not intended to be limited to IGMP messages, but includes other types of messages. For example, IGMP version 3 messages may be used to maintain at least one most recently viewed video service.

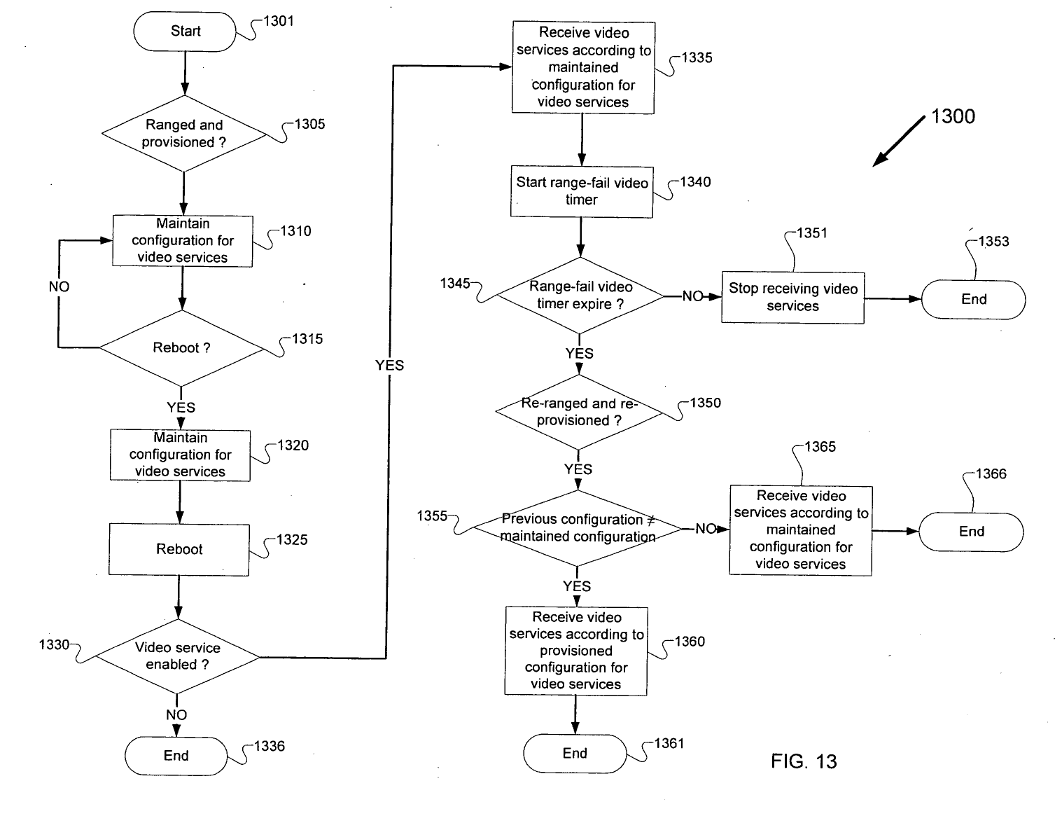

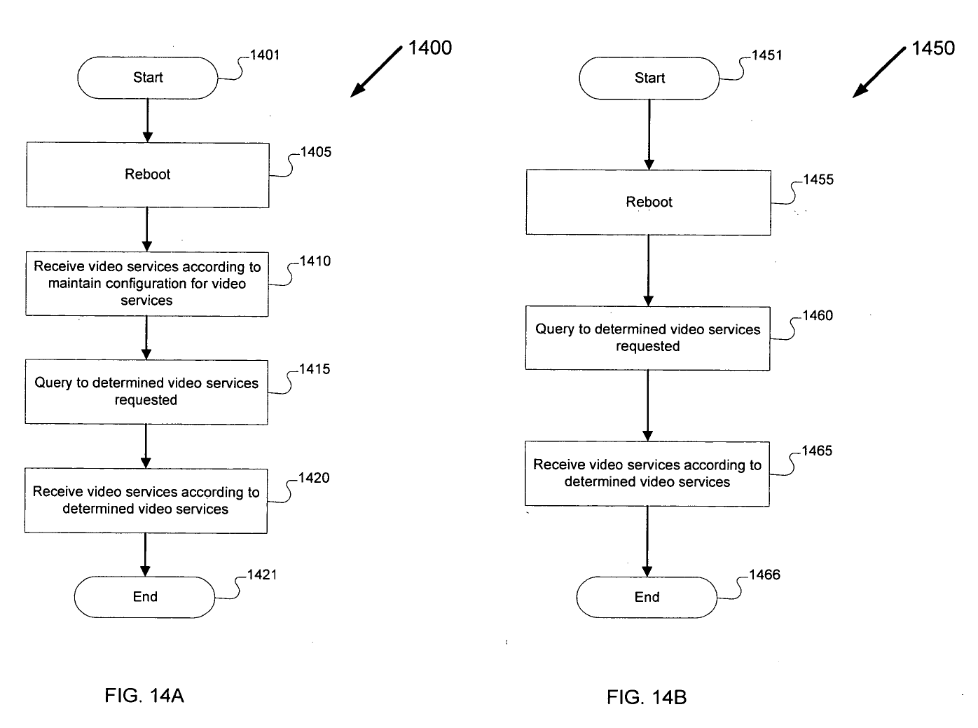

FIG. 12 is chart which provides an overview of events occurring at an OLT 1205, ONT 1210, and set-top box/television (STB/TV) 1215 at three different instances in time, 1201a, 1201b, and 1201c. The details of individual events are provided below in reference to FIGS. 13 and 14.

Continuing to refer to FIG. 12, in the first instance 1201a, at substantially about a time before the ONT 1210 is rebooted and re-ranged, at the OLT 1205, a configuration for IP video services is provisioned (1220). At the ONT 1210, the provisioned configuration for IP video services is maintained (1225). At the set-top box/television 1215, a first IP video channel, for example HOME BOX OFFICE (HBO), is being watched (1230).

Maintaining a configuration for IP video services at the ONT 1215 includes maintaining, for example, a state of receipt of video services, downstream communications path for delivering video services, list of allowable video services, at least one video service previously viewed, range-fail timer to ensure that video services are no longer provided in an event the ONT 1215 is not re-ranged within a certain amount of time, and any information necessary to access a downstream communications wavelength (e.g., the wavelength of 1490 nm used by the downstream communications 715 of FIG. 7).

In the second instance 1201b, at substantially about a time after the ONT 1210 is rebooted and waiting to be re-ranged, at the OLT 1205, a reboot command is issued (1235) to reboot the ONT 1210, for example, to upgrade the ONT 1210. At the ONT 1210, IP video services are received (1240) according to the maintained configuration for IP video services for an amount of time defined by a default value or other defined value. For example, IP video services are received (1240) during a period from a time the ONT 1210 is rebooted to a time the ONT 1210 is ranged and provisioned. In this way, at the set-top box/television 1215, the first IP video channel (HBO) may still be watched even though the ONT 1210 is not yet ranged and provisioned for upstream communications.

Alternatively, at the set-top box/television 1215, the first IP video channel (HBO) may be switched or otherwise changed and a second IP video channel, for example SHOWTIME (SHO) is being watched (1245).

In the third instance 1201c, at substantially about a time the ONT 1210 is rebooted and re-ranged, at the OLT 1205, a second configuration for IP video service is provisioned (1250). At the ONT 1210, the second configuration (i.e., the provisioned configuration) is given precedence (1255) over the maintained configuration for IP video services in an event the maintained configuration differs from the provisioned configuration. For example, an IP video channel previously allowed or available in the maintained configuration is no longer allowed in the provisioned configuration. In the example illustrated in FIG. 12, the previously allowed IP video channel SHO is no longer allowed. Consequently, at the set-top box/television 1215, the second IP video channel cannot be watched (1260).

FIG. 13 is a flowchart of an example process 1300 for ensuring continuous video service based on conditions in a PON. The process 1300 starts (1301). The process 1300 determines (1305) whether an ONT has been ranged and provisioned with, for example, a configuration for video services. If the process 1300 determines (1305) the ONT has been ranged and provisioned, the process 1300 maintains (1310) a configuration for video services.

The process 1300 maintains (1310) the configuration for video services by maintaining, for example, the following information: a state (or mode) of receipt of the video services, downstream communications path for delivering the video services, list of allowable video services, at least one video service previously viewed, range-fail timer to ensure that an ONT stops providing video services in an event the ONT is not re-ranged within a certain amount of time, and any information necessary to access a downstream communications wavelength. For example, the process 1300 maintains (1310) the configuration for video services by maintaining: an IP video service state (i.e., whether IP video services is enabled or disabled); VCC or GEM Port ID containing all of the IP video channels, allowable lineup of IP video channels; IP video channel current being viewed, and information necessary to access a downstream 1490 nm signal.

In another example, the process 1300 maintains (1310) the configuration for video services by maintaining, for example, substantially the same information as the previous example with the exception of the allowable lineup of IP video channels. In some instances, an ONT is configured with a pre-configured list of IP video channels to which a customer has access.

The process 1300 maintains (1310) the configuration for video services by storing the maintained configuration for video services internal to the ONT, for example, in FLASH or nonvolatile random access memory (NVRAM).

Continuing with FIG. 13, the process 1300 determines (1315) whether the ONT is to be rebooted, for example, whether a command has been issued to reboot the ONT or the ONT is being upgraded. The process 1300 maintains (1320) the configuration for video services as described above. The process 1300 reboots (1325) the ONT.

However, if the process 1300 determines (1315) the ONT is not to be rebooted (e.g., the ONT is operating normally), the process 1300 continues to maintain (1310) the configuration for video services. For example, the configuration for video services may be maintained (1310) on a periodic or scheduled basis. Alternatively, the configuration for video services may be maintained (1310) in response to an event (e.g., a loss of power) or is otherwise event driven.

The process 1300 determines (1330) whether video services are enabled. If the process 1300 determines (1330) video services are enabled, the process 1300 receives (1335) video services according to the maintained configuration for video services. However, if the process 1300 determines (1330) video services are not enabled the process 1300 ends (1336).

If video service are enabled (1330), the ONT receives (1335) video services according to a maintained configuration for video services. Thereafter, the process 1300 starts (1340) a range-fail video timer. The range-fail video timer is set for a default amount of time. For example, the default amount of time which is set can take into consideration the amount of time for a PON card (or other relevant cards/equipment in an OLT) to reboot plus the amount of time for the PON card to range all ONTs on a PON. Consider the following example. Assume it takes 1 minute for a PON card to reboot and another 2 minutes to re-range and provision all ONTs on a PON. In this example, it may be appropriate to set the range-fail video timer to 3-5 minutes. In this way, when the range-fail video timer expires, it may be assumed that the PON card had an opportunity to reboot, and the ONTs in the PON had an opportunity to be re-ranged and provisioned. In another example, the default amount of time which is set provides a sufficient amount of time for troubleshooting purposes. In yet another example, the default amount of time is set to a value determined by a customer.

The default amount of time set may be stored in the ONT, for example, in FLASH memory or nonvolatile random access memory (NVRAM). Additionally, the default amount of time set may also be updated, for example, locally by a technician or remotely by an element management system (EMS). The range-fail video timer may be any type of timing mechanism capable of measuring or providing information for measuring a given length of time, such as a counter or a monitoring device monitoring a clock.

The process 1300 determines (1345) whether the range-fail video timer has expired. If the process 1300 determines (1345) that the range-fail video timer has expired, the process 1300 stops (1351) receiving video services, and the process 1300 ends (1353). However, if the process 1300 determines (1345) that the range-fail video has not expired, the process 1300 determines (1350) whether the ONT has been re-ranged and re-provisioned with, for example, another configuration for video services.

If the process 1300 determines (1350) that the ONT has been re-ranged and re-provisioned, the process 1300 determines (1355) whether the provisioned configuration for video services differs from the maintained configuration for video services. If the process 1300 determines (1355) that the provisioned configuration for video services differs from the maintained configuration for video services, the process 1300 receives (1360) video services according to the provisioned configuration for video services. In this way, precedence or priority is given to a configuration for video services provisioned by a second PON element, such as an OLT, in an event the maintained configuration for video services differs from the configuration for video services provisioned by the second PON element. After receiving the video service (1360), the process 1300 ends (1361).

If, however, the process 1300 determines (1355) that provisioned configuration for video services is the same or is otherwise equal to the maintained configuration for video services, the process 1300 receives (1365) video services according to either the maintained configuration for video services or the provisioned configuration for video service, and then the process 1300 ends (1366).

As described above in reference to FIG. 11A, when an IP video channel is changed or is otherwise switched from a first IP video channel to a second IP video channel, an ONT is aware of “leave” and “join messages” indicating which IP video channels were viewed before and after a user changed IP video channels. In this way, a video service currently being viewed may be determined by monitoring “leave” and “join” messages used to request a change from a first video service to a second video service.

It is possible, however, that an IP video channel is changed or is otherwise switched from a first IP video channel to a second IP video channel from a time when an ONT reboots to a time when the ONT re-gains access to the provided IP video services. Until further notice, the ONT may still only have knowledge of the first IP video channel (e.g., from a maintained configuration) viewed prior to the ONT rebooting. In other words, the configuration for video services maintained by the ONT is stale and does not represent a current configuration for IP video services.

FIG. 14A illustrates an example process 1400 for maintaining at least one video service previously viewed while alleviating the problem of a stale maintained configuration for video services. The process 1400 starts (1401). The process 1400 reboots (1405). The process 1400 receives (1410) video services according to a maintained configuration for video services. The process 1400 queries (1415) to determine a video service requested. For example, an ONT may send a query message to a set-top box, as described above in reference to FIG. 11B. The process 1400 receives (1420) video services according to the video services determined. The process 1400 ends (1421).

The following example illustrates maintaining at least one video service viewed in accordance with an embodiment of the present invention. The ONT reboots and forwards an IP video channel (or IP video stream) last known to the ONT. The ONT sends an IGMP membership query to a customer's set-top box or IGMP client to determine which IP video channel was last requested by the IGMP client. The ONT receives an IGMP membership report indicating which IP video channel was last requested and ensures that the last requested IP video channel is delivered to the IGMP client. As such, at least one video service previously viewed is maintained while the problem of a stale maintained configuration for video services is alleviated.

FIG. 14B illustrates an alternative process 1450 for maintaining at least one video service previously viewed while alleviating the problem of a stale maintained configuration for video services. The process 1450 starts (1451). The process 1400 reboots (1455). The process 1450 queries (1460) to determine a video service requested. For example, an ONT may send a query message to a set-top box, as described above in reference to FIG. 11B. The process 1400 receives (1465) video services according to the video services determined. The process 1400 ends (1466).

The following example illustrates maintaining at least one video service previously viewed in accordance with an embodiment of the present invention. The ONT reboots, but, unlike the previous example, the ONT does not forward an IP video channel (or IP video stream) known to the ONT. The ONT sends an IGMP Group Membership Query message to the customer's set-top box or IGMP client to determine which IP video channel was last requested by the IGMP client. The ONT receives IGMP Multicast Membership Report message indicating which IP video channel was last requested and ensures that the last requested IP video channel is delivered to the IGMP client. As such, at least one video service previously viewed is maintained while the problem of a stale maintained configuration for video services is alleviated.

One difference, for example, between the process 1400 (illustrated in FIG. 14A) and the alternative process 1450 (illustrated in FIG. 14B) is an amount of time taken to provide a last requested IP video channel to a customer (i.e., the IP video channel actually being delivered to the customer). In some instances, for example, when a reboot occurs early in the morning or late at night when the customer is not likely to be changing channel or otherwise channel “surfing,” maintaining at least one video service previously viewed according to the process 1400 illustrated in FIG. 14A may be preferable. In contrast, when a reboot occurs in the middle of the day when the customer is likely to be channel “surfing”, maintaining at least one video service previously viewed according to the process 1450 illustrated in FIG. 14B may instead be preferable.

In contrast to the embodiments described in reference to FIGS. 14A and 14B, other embodiments of the present invention contemplate alternative behaviors. In particular, several embodiments consider how to handle a change from a first IP video service to a second IP video service when an ONT is not yet re-ranged. Recall, while an ONT may not yet be ranged and provisioned for upstream communications with an OLT (i.e., messages or data cannot be sent from the ONT to the OLT), downstream communications with the ONT may still be possible and services may still be provided over a downstream communications path.

In one embodiment, messages or signals identifying or otherwise indicating a change from a first IP video service to a second IP video service (e.g., the “leave” message 1108 and the “join” message 1112 of FIG. 11A) are discarded until an ONT is re-ranged. At a minimum, however, the embodiment allows the first IP video service to continue to be provided (and thus viewed by a customer) until the ONT is re-ranged.

In another embodiment, a second IP video service is provided according to messages or signals identifying a change from a first IP video service to the second IP video service. If, however, the second IP video service is not presently being provided on a downstream communications path for IP video services (i.e., it is not available on a PON), the first IP video service is not changed to the second IP video service. The first IP video service is changed to the second IP video service when the second IP video service becomes available on the PON, e.g., when another ONT, which has been ranged, requests the second IP video service or until the ONT is re-ranged (and thus upstream communications with the OLT are possible) and requests the second IP video service for itself.

Another alternative includes an ONT maintaining knowledge of messages or signals identifying a change from a first IP video service to a second IP video service while the ONT is not yet re-ranged. Once re-ranged and upstream communications with an OLT are possible, such messages are then communicated to the OLT.

Yet another alternative includes auditing an ONT (e.g., using the query message described in reference to FIG. 11B) once the ONT is re-ranged. The ONT communicates with an OLT (e.g., using the “join” message described in reference to FIG. 11A) an IP video service currently being provided to a customer once upstream communications with the OLT are possible.

Under normal operating conditions, when an OLT (or a PON card in the OLT) reboots all ONTs on the PON are re-ranged. The ONTs are said to have “lost” ranging with an OLT. Until an ONT is re-ranged, upstream communications with the OLT is not possible. Downstream communications with the ONT, on the other hand, is possible. Consequently, the OLT may setup or otherwise establish a downstream communications path for IP video services. In this way, even before the ONT is ranged with the OLT, the ONT has access to the downstream communications path for IP video services and may begin providing IP video services to a customer. However, the ONT may or may not be aware or otherwise know whether the downstream communications path for IP video services is established and/or whether IP video services are available to be provided to the customer

Accordingly, in one embodiment of the present invention, in an event an ONT “loses” ranging with an OLT, for example, when the OLT reboots or when there is temporary loss of signal condition between the ONT and the OLT, a downstream communications path for IP video services (e.g., a VCC or a GEM Port ID) is monitored for available IP video services. The downstream communications path may be monitored for an amount of time defined by a default value. For example, the downstream communications path may be monitored for available IP video services starting from when an ONT loses ranging with an OLT until a range-fail video timer (described in reference to FIG. 13) expires.

At the expiration of such an amount of time, if the ONT has not been re-ranged, the ONT may stop monitoring the downstream communications path for IP video services for available IP video services. In such an instance, it may be assumed that there are problems in the ability of the OLT to deliver IP video services on the PON. Furthermore, since the ONT has not been re-ranged, it may also be assumed that there are problems with this specific ONT in general.

In this way, a downstream communications path for IP video services is monitored for available video services in an event an ONT loses ranging with an OLT.

In another embodiment of the present invention, prior to an OLT rebooting (and thus prior to ONTs losing ranging with the OLT) the OLT sends a message to the ONTs indicating that a controlled action in the OLT has occurred or is substantially about to occur. The ONTs may therefore continue monitoring a downstream communications path for IP video services (e.g., a VCC or GEM Port ID) for available IP video services.

For example, the OLT may send an upgrade/reboot indication message (URIM) to all the ONTs on a PON prior to rebooting. ONTs receiving such a message may or may not decide to continue monitoring the downstream communications path for IP video services for available video services for an amount of time defined by a default value. ONTs not receiving such a message or receiving some other message, however, may perform other actions, e.g., stop monitoring the downstream communications for IP video services for available IP video services.

In yet another embodiment of the present invention, when an OLT (or a PON card in the OLT) successfully boots up following a reboot, the OLT may send a general broadcast message to all ONTs on the PON that IP video services are available over a downstream communications path for IP video services. Accordingly, as long as the ONTs have knowledge of and have access to the downstream communications path (e.g., by maintaining a configuration described in the reference to FIG. 12) and the ONTs receive the general broadcast message over the downstream communications path of IP video services, the ONTs are aware that IP video services are available over such a path. In this way, a downstream communications path for IP video services is monitored for a message indicating video services are available, in an event an ONT loses ranging with an OLT.

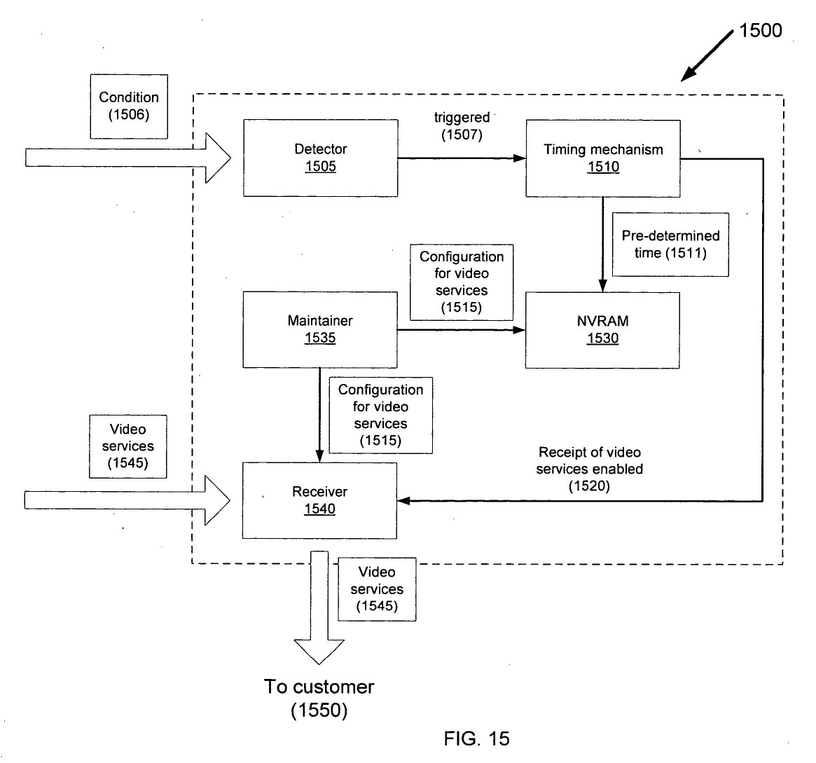

FIG. 15 illustrates an example passive optical network (PON) element 1500 for ensuring continuous receipt of video services. The PON element 1500 includes a detector 1505 to detect a condition 1506 indicating a change of state in receipt of video services. Coupled to the detector 1505 is a timing mechanism 1510 to enable video services for a predetermined (or dynamic) amount of time 1511.

In an event the detector 1505 detects the condition 1506 indicating a change of state in receipt of video services, such as a loss of ranging or a loss of signal, the timing mechanism 1510 is triggered (represented by reference number 1507). The timing mechanism 1510 enables receipt of video services (represented by reference number 1520). The PON element 1500 enables (1520) receipt of video services for the predetermined amount of time 1511. In one embodiment of the present invention, the timing mechanism 1510 disables receipt of video services when the predetermined amount of time 1511 expires. It should be understood that video services may also be disabled after a predetermined amount of time by disabling transmission of video services towards a customer or subscriber.

The timing mechanism 1510 may be coupled to a nonvolatile random access memory (NVRAM) 1530 or FLASH. The NVRAM 1530 stores the predetermined amount of time 1511. While the predetermined amount of time 1511 may be stored internally in (or “internal to”) the PON element 1500, the predetermined amount of time 1511 may be changed by a remote or external source (not shown).

The PON element 1500 may also include a maintainer 1535 to maintain a configuration for video services 1515 in a manner described in reference to FIG. 12. The NVRAM 1530 may be coupled to the maintainer 1535 to maintain or otherwise store the maintained configuration for video services 1515.

The PON element 1500 may also include a receiver 1540 to receive video services 1545 according to the maintained configuration for video services 1515. The timing mechanism 1510 may be coupled to the receiver 1540. In this way, receipt of the video services 1545 is enabled for the predetermined amount of time 1511, and the video services 1545 are received according to the maintained configuration for video services 1515. The PON element 1500 provides the video services 1545 to a customer (or subscriber) 1550. In this way, the PON element 1500 controls and monitors the receipt and transmission of the video services 1545 to the customer 1550.

One or more of the above elements may be implemented in a microprocessor, for example, the microprocessor of FIG. 2. Alternatively, one or more of the above elements may be implemented in software written to be executed by the microprocessor. One skilled in the art will really recognize that where the above elements are implemented is not of significance, but rather what functions are performed by the above elements are of significance.

While this invention has been particularly shown and described with references to preferred embodiments thereof, it will be understood by those skilled in the art that various changes in form and details may be made therein without departing from the scope of the invention encompassed by the appended claims.

Although described as “cards” herein, it should be understood that PON cards, OLT cards, or ONT cards may be systems or subsystems without departing from the principles disclosed hereinabove.

The timer may be a count-up timer, count-down timer, or any form of timer that can be used for maintaining the ONT in an enabled state for a given length of time.

Although described in reference to a passive optical network, the same or other embodiments of the present invention may be employed in an active optical network, data communications network, or any other type of network.

Any of the flowcharts or certain elements disclosed in reference to block diagrams, e.g., timing mechanism 1510 or maintainer 1535 of FIG. 15, may be implemented in hardware, firmware, or software. If implemented in software, the software may be written in any suitable language and stored.

What is claimed is:

1. A method of ensuring continuous video services based on certain conditions in a passive optical network (PON), the method comprising:
detecting at a PON element a condition indicating a change of states in video services;
triggering a timing mechanism having a default value stored in the PON element; and
enabling receipt of video services at the PON element for an amount of time defined by the default value.

2. The method according to claim 1 wherein enabling receipt of video services at the PON element for the amount of time defined by the default value includes:
maintaining a configuration for video services previously provisioned; and
receiving video services according to the maintained configuration for video services for the amount of time defined by the default value.

3. The method according to claim 2 wherein receiving video services according to the maintained configuration for video services includes giving precedence to a configuration for video services provisioned by a second PON element in an event the maintained configuration for video services differs from the configuration for video services provisioned by the second PON element.

4. The method according to claim 2 wherein maintaining the configuration for video services previously provisioned includes maintaining the configuration for video services internal to the PON element.

5. The method according to claim 2 wherein maintaining the configuration for video services previously provisioned includes:
maintaining a state of receipt of the video services; and
maintaining at least one downstream communications path for video services for delivering the video services.

6. The method according to claim 5 further includes:
maintaining a list of allowable video services; and
maintaining at least one last video service previously viewed.

7. The method according to claim 6 wherein maintaining the at least one last video service previously viewed includes monitoring for Internet Group Management Protocol (IGMP) Multicast Membership Report and IGMP Multicast Leave Group Membership messages indicating a change from a first video service to a second video service.

8. The method according to claim 6 wherein maintaining the at least one last video service viewed includes sending an IGMP Group Membership Query message to determine at least one video service requested.

9. The method according to claim 2 further comprising determining whether video services, receipt of which is to be enabled, are available by monitoring a downstream communications path for available video services.

10. The method according to claim 9 wherein monitoring the downstream communications path for available video services includes monitoring the downstream communications path for a message indicating video services are available.

11. The method according to claim 1 further comprising changing the default value of the timing mechanism from a remote or external source.

12. The method according to claim 1 further comprising storing the default value of the timing mechanism in nonvolatile memory.

13. The method according to claim 1 wherein the change of states includes at least one of the following:
fiber-break in certain segments of the PON;
the PON element reboots for purposes of troubleshooting or upgrading the PON element;
the PON card or other line card reboots or is replaced with another line card;
poor connections with some Optical Distribution Network (ODN); or
a misbehaving PON element causes faulty communications between PON elements.

14. The method according to claim 1 further comprising causing the PON element to enter a provisioned video service mode in an event the amount of time defined by the default value ends, the provisioned video service mode using information provided by another PON element.

15. The method according to claim 1 further comprising returning the timing mechanism to its original state in an event a loss of ranging occurs.

16. The method according to claim 1 further comprising disabling receipt of video services after the amount of time defined by the timing mechanism expires.

17. The method according to claim 1 further comprising disabling transmission of video services toward a customer after the amount of time defined by the timing mechanism expires.

18. A passive optical network (PON) element to ensure continuous receipt of video services based on certain conditions in a PON, the PON element comprising:
a detector to detect a condition indicating a change of states in receipt of video services; and
a timing mechanism coupled to the detector to enable receipt of video services at the PON element for a predetermined amount of time.

19. The PON element according to claim 18 wherein the timing mechanism disables receipt of video services at the PON element after the predetermined amount of time.

20. The PON element according to claim 18 wherein the timing mechanism disables transmission of the video services toward a customer after the predetermined amount of time.

21. The PON element according to claim 18 wherein the value of the predetermined amount of time is changed by a remote or external source.

22. The PON element according to claim 18 wherein the change of states includes at least one of the following:
fiber-break in certain segments of the PON;
the PON element reboots for purposes of troubleshooting or upgrading the PON element;
the PON card or other line card reboots or is replaced with another line card;
poor connections with some Optical Distribution Network (ODN); and
a misbehaving PON element causes faulty communications between PON elements.

23. The PON element according to claim 18 further comprising;
a maintainer to maintain a configuration for video services previously provisioned; and
a receiver to receive video services according to the maintained configuration for video services for a predetermined amount of time.

24. The PON element according to claim 18 further comprising nonvolatile memory coupled to the maintainer to store the maintained configuration for video services previously provisioned.

25. The PON element according to claim 24 wherein the nonvolatile memory is coupled to the timing mechanism to store a value of the predetermined amount of time.

26. A computer program product comprising a computer usable medium embodying computer usable code to ensure continuous video services based on certain conditions in a passive optical network (PON), the computer program product including computer usable program code, which when executed by a processor, causes the processor to:
detect at a PON element a condition indicating a change of states in video services;
trigger a timing mechanism having a default value stored in the PON element; and
enable receipt of video services at the PON element for an amount of time defined by the default value.
